(19) United States
(12) Patent Application Publication
(10) Pub. No.: US 2003/0051622 A1
(43) Pub. Date: Mar. 20, 2003

(54) Printing vehicle and method for producing and distributing printed matter

(75) Inventors: Yoshikazu Tanaka, Kyoto (JP); Osamu Kitagawa, Kyoto (JP); Yoshihiro Katsuma, Kyoto (JP)

Correspondence Address: MCDERMOTT, WILL & EMERY, 600 13th Street, N.W., WASHINGTON, DC, 20005-3096, US

(73) Assignee: Dainippon Screen Mfg. Co., Ltd.

(21) Appl. No.: 10/243,913

(22) Filed: Sep. 16, 2002

(30) Foreign Application Priority Data
Sep. 17, 2001 (JP) P2001-280855

(51) Int. Cl. B41F 1/34

(52) U.S. Cl. 101/480; 101/483

(57) ABSTRACT

In order to simplify printing on the site of an event or the like, a printing vehicle comprises a movable car body comprising tires, an image data processor comprised in the car body and a printing press performing printing on the basis of printing data created by the image data processor. It is possible to move to the site of the event or the like with this printing vehicle for editing image data acquired on the site itself by the image data processor and performing printing. Thus, printed matters related to the event can be created substantially in real time, for arousing demands of purchasers.

### BACKGROUND OF THE INVENTION

1. Field of the Invention

The present invention relates to a printing vehicle adopted for outdoor printing and method for producing and distributing printed matter on a spot.

2. Description of the Background Art

In general, distribution service is performed on a spot such as an exhibition place or a sporting stadium for distributing printed matters such as newspapers, leaflets or extras carrying a related account at a charge or free of charge. In such distribution service, the printed matters are in a printing factory outside the spot and delivered to the spot.

In general, printing is performed outside the spot through the following manufacturing procedure: First, data of images acquired on the spot, text data related to materials collected on the spot and the like are edited in an edit section, so that printed matters are printed on a prescribed printing factory on the basis of edited printing data.

### SUMMARY OF THE INVENTION

The present invention has for its object a printing vehicle adopted for outdoor printing and a method for producing and distributing printed matters on a spot.

According to this invention, a printing vehicle adopted for outdoor printing comprises: (a) a plurality of wheels; (b) a power source for driving at least one of the plurality of wheels; (c) a body mounted above the plurality of wheels; (d) a printing press enclosed in the body; and (e) electric lines for supplying electric power to the printing press, the printing press being supplied with electric power through the electric lines and enabling to produce a plurality of printed matters each of which has the same contents as others, by transferring images to a plurality of mediums for printing, and the plurality of printed matters distributed to the people neighboring of the printing vehicle.

According to this invention, a method for producing and distributing printed matters comprises the steps of: (f) moving a printing vehicle mounting a printing press from a first location to a second location; (g) acquiring local information in a third location, which is either the neighborhood of the second location or other location; (h) deciding layouts of the printed matters, combining the local information with base information; (i) executing printing based on the layouts to a plurality of printing mediums by the printing press mounted on the printing vehicle to acquire a plurality of printed matters; and (j) distributing the plurality of printed matters at the second location.

According to the present invention, an image highly in demand then and there, such as one for the books in an arbitrary event such as a concert, a sport match or an exhibition, for example, or a commemorative scene for visitors of the event can be acquired as image data for immediately creating printing data by performing layout or the like. Further, printing can be performed on the basis of the printing data on the spot or in another arbitrary place for distributing the image as printed matters to the public visiting this place.

Accordingly, an object of the present invention is to provide a printing vehicle movable to an arbitrary place and to distribute printed matters including an image acquired on a prescribed spot such as that of an event on the spot or in another arbitrary place immediately after acquisition.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically illustrates an exemplary structure of a printing vehicle according to the present invention;

FIG. 2 is a flow chart showing an exemplary procedure of a mobile printing service method according to the present invention;

FIG. 3 is a flow chart showing another exemplary procedure of the mobile printing service method according to the present invention; and

FIG. 4 is a flow chart showing still another exemplary procedure of the mobile printing service method according to the present invention.

### DESCRIPTION OF THE PREFERRED EMBODIMENTS

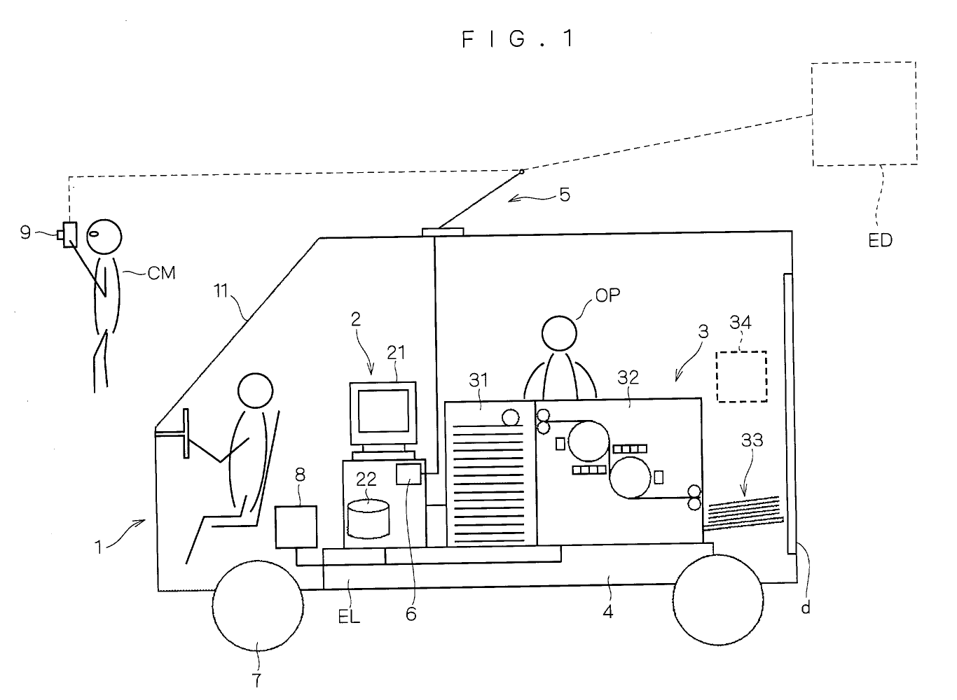

An embodiment of the present invention is now described with reference to FIGS. 1 to 4. FIG. 1 is a schematic front elevational view showing an exemplary printing vehicle 1 employed in the present invention. Referring to FIG. 1, the printing vehicle 1 comprises a movable car body 11 comprising tires 7, an image data processor 2 comprised on the car body 11 and a printing press 3 performing printing on the basis of printing data created by the image data processor 2.

The printing vehicle 1, preferably consisting of a self-propelled automobile such as a minivan or a trailer, can be loaded with the image data processor 2, the printing press 3 and the like. The printing vehicle 1 further comprises a space enabling an operator OP to perform printing operation therein. Alternatively, another automobile may tow the car body 11.

The car body 11 comprises an electric power line EL for supplying power to the image data processor 2 and the printing press 3. The car body 11 preferably further comprises a power supply 8 capable of individually supplying power. The power supply 8 is formed by a power generator or a battery, for example. Alternatively, power may be supplied from a receptacle provided in a building or the like when the printing vehicle 1 stops. When the printing press 3 employs some water for offset printing or the like, for example, the car body 11 stores water supply equipment (not shown) or a piping installation connectable to external city water or the like. The car body 11 further comprises a door d preferably in the vicinity of a stocker 33 (described later) of the printing press 3 so that a printed matter discharge side of the printing press 3 is externally accessible from outside the printing vehicle 1. In other words, the printed matter discharge side of the printing press 3 is directed toward the door d, so that printed matters can be readily extracted from the printing vehicle 1.

The image data processor 2 is formed by a DTP (desktop publishing) apparatus or the like for performing the so-called prepress, and comprises display means such as a CRT, input means such as a keyboard and a mouse, arithmetic means running programs, a storage unit 22 serving as storage means storing image data, layout data etc., a microcomputer system 21 comprising various interfaces for connecting a digital camera 9, a communication device etc., and software for driving the microcomputer system 21 as the image data processor 2. This image data processor 2 has a function for serving as an input element fetching image data acquired through the digital camera 9 or the like and a function for serving as a layout element synthesizing text data, line drawings etc. input from the keyboard or the like with the image data and performing layout editing, so that printing data can be created by this edit operation.

In order to facilitate understanding of various data in the present invention, a baseball game in a stadium is now described as an exemplary event. A cameraman (or an operator) CM or the like picks up an image of a home run scene or the like taking place in a prescribed inning. The obtained image data (pickup data) is local information obtainable only in the stadium. The pickup data obtained as the local information is input in the image data processor 2 and synthesized with various data related to this scene or the game, i.e., base information such as the name of the player hitting the home run, his record data such as the number of his home runs, text data such as the date of the game and image data of the mark of the baseball team and the autograph of the player. Thus, printing data for forming posters or picture postcards is created. For example, the names of the players, the name of the adversary team and the like may be previously set in a database so as to be selectively indicated. When the sizes, positions etc. for arranging the aforementioned various data are previously selected from several patterns of layout data, the edit operation is simplified.

In a concert hall, local information such as pickup data of artists acquired in the hall is synthesized with base information including text data such as the names of the artists, the name of the concert hall and the date of the concert and image data of autographs of the artists or the like for creating printing data similarly to the above. In an exhibition or the like, local information corresponding to pickup data showing the situation of the exhibitory space, the exhibitory works etc. is synthesized with base information such as account data for creating printing data in the form of newspapers, for example.

Throughout the specification, a game of baseball or association football, a concert or an autograph party by a singer, an exhibition or an announcement event of products or the like, a recording event or a press conference for a television program or a movie, an event held on an amusement park or the like, a public event organized by a community or the like are generically referred to as “event”. Further, the spot for holding the event is referred to generically as “event site” or simply as “site” regardless of presence/absence of a building. In addition, it is assumed that the term “event site” or “site” includes not only the location of the site for holding the event but also portions around the site such as roads and the traffic system in the vicinity of the site, for example.

The printing press 3 performing printing on the basis of the printing data is preferably formed by a digital printing machine capable of small-lot printing with a short time for starting printing and a high processing speed. For example, a high-speed output machine of a color electrophotographic system or an ink jet system (such as an on-demand printing system “Ultra Stream 2000” or an ink jet digital printing system “True Press Jet” by Dainippon Screen Mfg. Co. Ltd., for example) corresponds thereto. Alternatively, a printing press (digital imaging system “True Press 544” by Dainippon Screen Mfg. Co. Ltd., or the like) comprising a CTP (computer-to-plate) mechanism performing plate making on a printing cylinder to execute offset printing is also employable.

This printing press 3 comprises holding means 31 previously holding a large number of printing sheets, a printing press body 32 performing printing on printing sheets fed from the holding means 31 and the stocker 33 receiving printed matters. The image data processor 2 and the printing press 3 are fixed to the car body 11 through a vibration suppressor 4. The vibration suppressor 4 is formed by a known shock absorber such as a pneumatic or hydraulic damper, is an apparatus actively performing posture control sensing vibration, and reduces influence exerted by vibration resulting from traveling preferably to a degree enabling printing also during traveling.

While single sheets of printing paper are employed in the aforementioned example, the holding means 31 may alternatively hold machine roll-type printing paper for cutting the same into single sheets at the later step of the performance on the printing press body 32. Further, prescribed images may be previously printed on the printing sheets for superpositionally printing images obtained on the event site thereon. Further, a well-known bookbinding machine 34 such as an adhesive binding machine, a folding machine or a laminator, for example, may be comprised on the post stage of the printing press 3, for creating pamphlets each formed by integrating a plurality of types of printed matters with each other, or various types of booklets. In addition, printing may be performable not on general printing sheets but on seals, telephone cards or various types of souvenirs. In this case, it follows that the printing vehicle 1 is loaded with a printing press responsive to such printing.

The printing press 3 creates printed matters such as posters, picture postcards, newspapers, pamphlets or telephone cards, for example, in real time as those expressing excitement caused during the event as such by employing pickup data acquired on the site. Thus, it is expected that attention of purchasers can be attracted. When distributed limitedly on the event site, the printed matters attain rarity value or commemorative value preferably as souvenirs on the event site. Throughout the specification, the term “during the event” includes a post-event period when purchasers still remain on the site as the substantial period of the event, in addition to the time for the event. In the case of the aforementioned baseball game, for example, the period up to the time when the stadium is emptied corresponds thereto.

While the printing data is created on the site in this embodiment, printing data created in an edit section ED outside the printing vehicle 1 may alternatively be received for performing printing therethrough. Thus, the printing vehicle 1 comprises an antenna 5 and a receiver 6 for wireless receiving, which are connected to the image data processor 2. The receiver 6 is formed by a portable communication terminal such as a Japanese PHS (personal handyphone system) terminal capable of transmitting data at a relatively high speed or a communication device capable of satellite communication, for example. The printing data obtained in this receiver 6 is preferably transmitted in a coded and compressed manner to be decoded in the image data processor 2, in order to reduce the transmission and reception time. The image data processor 2 also includes a decoding function or the like. The Internet (broadband Internet) may be employed as the communication means.

In this case, the image data processor 2 may receive not all but partial printing data, for synthesizing pickup data or the like acquired on the site with the received data. Alternatively, printing data edited in the image data processor 2 or image data may be transmitted to another printing press or another printing vehicle present on another place for distributing printed matters in association with another event site or the like. As to events held on a plurality of sites at the same time such as the Olympic Games or the World Cup games, for example, it is conceivable to prepare and distribute printed matters including results in various sites. Throughout the specification, the term “distribution” includes both of gratis distribution and distribution at a charge, i.e., selling.

While the image data processor 2 and the printing press 3 are separated from each other in this embodiment, the same may alternatively be integrated with each other so that a control computer provided on the printing press 3 also performs processing of image data employed for printing along with control of printing.

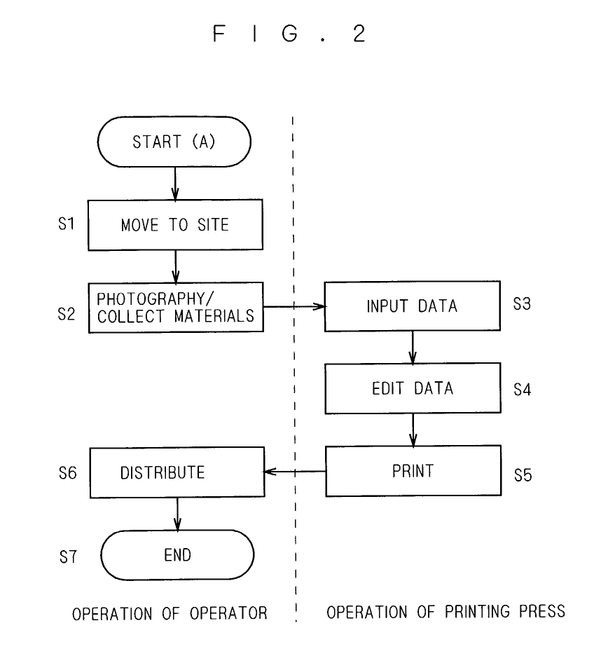

Now steps of creating and distributing printed matters according to the present invention are described with reference to FIGS. 2 to 4. FIGS. 2 to 4 are flow charts showing some representative creation and distribution modes.

In the flow shown in FIG. 2, the printing vehicle 1 moves to the event site at a step S1. At a step S2, a scene is photographed on the event site and an account related to the event is created. One operator may perform photography at the step S2 while another operator drives the printing vehicle 1 to the event site, as a matter of course.

At a step S3, acquired pickup data, text data such as manuscript data are input in the image data processor 2. For example, the pickup data is transferred from the digital camera 9 to the image data processor 2 through a well-known connecting port. Further, the text data of the manuscripts is directly input through the keyboard comprised in the image data processor 2, or it is created in a word processor to be input.

At a step S4, the image data processor 2 lays out the image data and the text data and creates printing data. The image data processor 2 may conceivably perform edit processing such as scaling or synthesis of images, color conversion or trimming, as a matter of course. For the purpose of simplification, it is preferable to previously prepare text data and layout data for laying out pickup data acquired on the spot. At a step S5, printing is performed on the basis of the created printing data. The finished printed matters are distributed at a step S6.

In this case, editing and printing on the site can be performed with the printing vehicle 1, whereby the time for preparing the printed matters can be reduced as compared with a system of delivering printed matters printed in another place. Further, it is possible to deal with a scene taking place then and there on the event. In addition, it is possible to move to various event sites for creating and distributing printed matters.

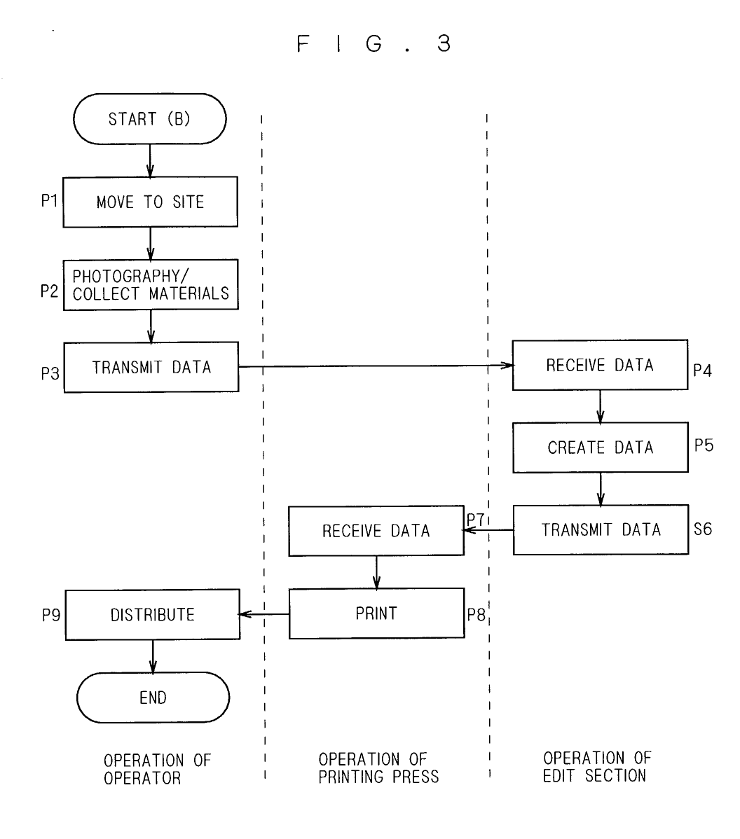

The flow chart in FIG. 3 is now described. At a step P1, the printing vehicle 1 moves to the site. At a step P2, photography, collection of materials and the like are performed. The steps P1 and P2 are identical to the aforementioned steps S1 and S2. At a subsequent step P3, acquired image data and text data are transmitted to the edit section ED provided outside the printing vehicle 1 by data communication. The edit section ED receives the transmitted data at a step P4, for creating printing data at a step P5.

The created printing data is transmitted from the edit section ED to the printing vehicle 1 at a step P6, and received at a step P7. Printing operation is performed at a step P8 through the received printing data. The image data processor 2 provided in the printing vehicle 1 may alternatively re-edit or replace the printing data before printing, or directly transfer the same to the printing press 3 as such, as a matter of course. Finished printed matters are distributed at a step P9.

In this case, image data editing or the like hard to perform in the printing vehicle 1 can be performed at the dedicated edit section ED, whereby printed matters requiring a relatively large quantity of prepress operation such as pamphlets consisting of a large number of pages, for example, can also be prepared when parallel processing is performed in numbers, for example. Further, the image data processor 2 provided in the printing vehicle 1 may advantageously comprise no editing function, as the case may be.

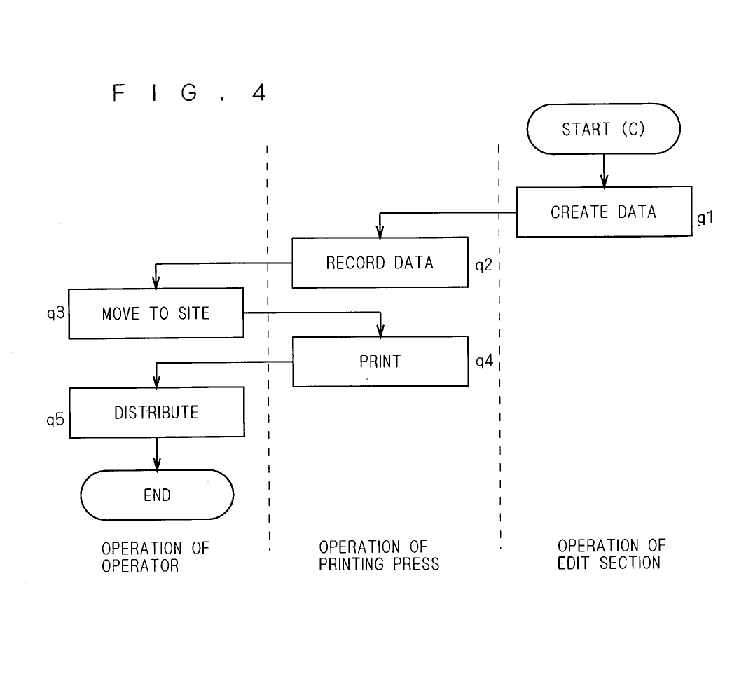

The flow chart of FIG. 4 is now described. In this flow, the edit section ED creates printing data at a step q1. At a step q2, the image data processor 2 provided in the printing vehicle 1 stores the printing data created in the edit section ED. A medium such as an optical disk, for example, may be employed for this storing. After such preparation, the printing vehicle 1 moves to the site at a step q3. At a step q4, printed matters are created by performing printing while moving to the site or after arrival at the site. At a step q5, the finished printed matters are distributed on the site.

While the printing vehicle 1 merely executes printing on the spot in this case, the time up to distribution is reduced as printing is performed while moving to the site. By performing printing under the very eyes of purchasers, a more attractive advertising effect can be expected as compared with the case of merely distributing the finished printed matters.

Modification

In the aforementioned embodiment, the printing vehicle 1 is so employed that printed matters can be advantageously created also outdoors, for example, with no printing equipment. On a site such as a franchise baseball stadium, for example, stationarily holding events, however, the printing press 3 may be comprised in the stadium or a near place regarded as substantially located in the stadium. By photographing a scene taking place in the stadium, creating printed matters on the basis of the image data and distributing the same in the stadium during an ongoing game substantially in real time, a demand of purchasers can be aroused and new needs to printing can be created. The above applies not only to the stadium but also to principal event sites, as a matter of course.

The process flow in this case can be implemented by excluding, the step S1 and P1 of each of the flow charts shown in FIGS. 2 and 3 and fixing the image data processor 2 and the printing press 3 in the vicinity of the site without movement, and hence redundant description is omitted.

While the invention has been shown and described in detail, the foregoing description is in all aspects illustrative and not restrictive. It is therefore understood that numerous modifications and variations can be devised without departing from the scope of the invention.

What is claimed is:

1. A printing vehicle adopted for outdoor printing, comprising:
(a) a plurality of wheels;
(b) a power source for driving at least one of said plurality of wheels;
(c) a body mounted above said plurality of wheels;
(d) a printing press enclosed in said body; and
(e) electric lines for supplying electric power to said printing press,
wherein said printing press being supplied with electric power through said electric lines and capable of producing a plurality of printed matters each of which has the same contents as others, by transferring images to a plurality of mediums for printing, and
said plurality of printed matters distributed to the neighboring people of said printing vehicle.

2. The printing vehicle according to claim 1, further comprising:
a vibration suppressor provided between said printing press and said body.

3. The printing vehicle according to claim 2, wherein
said printing press further comprises:
an input element inputting local information to said printing press; and
a layout element layouting printing data, and
said printing data is layouted combining said local information with base information.

4. The printing vehicle according to claim 3, wherein
said printing vehicle further comprises a storage apparatus, and
said base information is stored in said storage apparatus.

5. The printing vehicle according to claim 4, wherein
said local information at least contains image data.

6. The printing vehicle according to claim 5, wherein
said input element comprises a wireless communication element which receives said local information wirelessly.

7. The printing vehicle according to claim 6, wherein
said body comprises a plurality of doors, and
said printing press comprises a stack element for stacking said plurality of printed matters, neighboring at least one of said plurality of doors.

8. The printing vehicle according to claim 7, wherein
said printing press further comprises a combine element which combines a plurality of printed matters different from each other into a one-piece material.

9. A method for producing and distributing printed matters, comprising the steps of:
(f) moving a printing vehicle mounting a printing press from a first location to a second location;
(g) acquiring local information in a third location, which is either the neighborhood of said second location or other location;
(h) deciding layouts of said printed matters, combining said local information with base information;
(i) executing printing based on said layouts to a plurality of printing mediums by said printing press mounted on said printing vehicle to acquire a plurality of printed matters; and
(j) distributing said plurality of printed matters at said second location.

10. The method according to claim 9, wherein
said base information is stored in a storage apparatus mounted on said printing vehicle.

11. The method according to claim 10, wherein
said base information is created in said printing vehicle.

12. The method according to claim 10, wherein
said step (h) is executed at an edit section outside said printing vehicle, and
said edit section comprising said base information availably.

13. The method according to claim 11, wherein
said local information is wirelessly communicated to said printing vehicle.

14. The method according to claim 13, wherein
said local information contains information about the scenes which occurred at said third location during the event.

15. The method according to claim 14, wherein
said local information at least comprises image data.

16. The method according to claim 15, wherein
said steps (g), (h), (i), and (j) are successively executed in appropriate timing to execute said step (g) and (j).

17. The method according to claim 16, wherein
said step (f) and at least one of said steps (g), (h), (i), and (j) are simultaneously executed.

18. The method according to claim 17, wherein
said third location is the site for either a sports match, a concert, or an exhibition.

19. A method for producing and distributing printed matters, comprising the steps of:
(k) acquiring image data in an event site by digital camera;
(l) deciding layouts of said printed matters, combining said image data at least with text data;
(m) executing printing based on said layouts to a plurality of printing mediums by printing press located in said event site to acquire a plurality of printed matters; and
(n) distributing said plurality of printed matters at said event site, and said steps (k), (l), (m) and (n) are successively executed during the event.

20. The method according to claim 19, wherein
said printed matter is either a poster, a picture postcard, a newspaper, a pamphlet, or a prepaid phone card as original souvenirs on the event.
